(19) United States
(12) Patent Application Publication
(10) Pub. No.: US 2022/0156884 A1
(43) Pub. Date: May 19, 2022

(54) ELECTRONIC DEVICE, METHOD AND COMPUTER PROGRAM

(71) Applicant: Sony Group Corporation, Tokyo (JP)

(72) Inventor: Thomas KEMP, Stuttgart (DE)

(73) Assignee: Sony Group Corporation, Tokyo (JP)

(21) Appl. No.: 17/598,885

(22) PCT Filed: May 5, 2020
(86) PCT No.: PCT/EP2020/062428

§ 371 Date: Sep. 28, 2021

(30) Foreign Application Priority Data
May 6, 2019 (EP) 19172785.8

(51) Int. Cl. G06T 3/40; G06N 3/08

(52) U.S. Cl. CPC G06T 3/4076; G06N 3/084; G06T 3/4046

(57) ABSTRACT

A method comprising training a pre-trained artificial neural network using degraded data together with higher-quality reference data to obtain an adapted artificial neural network.

### TECHNICAL FIELD

The present disclosure generally pertains to the field of image and video processing, in particular to devices, methods and systems for image upscaling.

### TECHNICAL BACKGROUND

In many applications, images or video data is captured with undesirable properties, like a resolution that is too low. This can be due to sensor imperfections—like lens errors—or price restrictions on the sensors, or sometimes due to losses during transmission (e.g. if the video bandwidth mandates the use of compression). For example, in many cases, images captured by cameras or by other means (e.g. NMR, CT, X-ray and the like) do not have the required properties with respect to resolution or aberrations, e.g. due to lens errors.

There exist upscaling techniques for image improvement. For example, it is known to provide a high-resolution image from a number of overlapping low resolution frames of the same scene. At the displaying device, an improved version of the image(s) is restored or displayed, e.g. a higher resolution image, an undistorted image, or the like. In video technology, for example, the magnification of digital images is known as upscaling or resolution enhancement. By enhancement, a clearer image with higher resolution is produced.

It is also known to use pre-trained Deep Neural Networks for image enhancement or upscaling. The network is trained with a low quality image at the input, and a high quality image at its output, and learns the mapping between the two images. Typically, this is done offline on a large database of image pairs. As much data is typically needed to achieve a high level of robustness this process takes substantial time to process.

Although there exist image upscaling techniques for image improvement, it is desirable to provide devices, methods and computer programs which provide an improved quality in image upscaling.

### SUMMARY

It is generally desirable to provide devices, methods and computer programs which provide an improved quality in image up scaling.

According to a first aspect the disclosure provides a computer-implemented method comprising a pre-trained artificial neural network using higher-quality reference data together with lower quality data to obtain an adapted artificial neural network.

According to a further aspect the disclosure provides an electronic device comprising circuitry configured to create an improved image from a degraded image by mapping the degraded image to the improved image with an adapted artificial neural network, wherein the adapted artificial neural network is obtained by training a pre-trained artificial neural network using degraded data together with higher-quality reference data

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 describes an operating room where high quality video data is taken by an endoscope and degrades by sending it through a bandwidth restricted PowerLAN connection to an operation surveillance room;

FIG. 2 describes an adaptation step of a pre-trained DNN that receives high quality video data and the corresponding degraded video data, where the DNN computations takes place in server;

FIG. 3 shows a flowchart that describes the process of adaptation of a pre-trained DNN as shown in FIG. 2;

FIG. 4 shows a flowchart that describes the operation of an adapted DNN after the adaptation step shown in FIG. 2 and FIG. 3 has taken place;

FIG. 5 describes an adaptation step of a pre-trained DNN that receives high quality video data and the corresponding degraded video data, where the DNN computations takes place in a cloud computing system;

FIG. 6 shows a flowchart that describes the process of adaptation of a pre-trained DNN as shown in FIG. 5;

FIG. 7 shows a flowchart that describes the operation of an adapted DNN after the adaptation step shown in FIG. 5 and FIG. 6 has taken place;

FIG. 8a-FIG. 8c schematically show an embodiment of pre-training, adapting and operating a DNN;

FIG. 8d shows a flowchart of the steps shown in FIG. 8a-FIG. 8c;

FIG. 9 schematically shows a process a of a DNN performing an adaptation step by aligning an improved image to a target image;

FIG. 10 shows a flowchart that describes the adaptation steps of the DNN by performing a gradient descent step; and

FIG. 11 schematically describes an embodiment of an electronic device which may implement the functionality of an artificial neural network.

### DETAILED DESCRIPTION OF EMBODIMENTS

The embodiments described below in more detail disclose a method comprising adapting a pre-trained artificial neural network using degraded data together with higher-quality reference data to obtain an adapted artificial neural network.

The pre-trained artificial neural network may in particular be adapted by performing a training process based on training data. This training data may comprise the degraded data. Adapting, respectively training the artificial neural network may for example comprise adapting weights related to the nodes of the artificial neural network. This adapting may for example be performed using a stochastic gradient descent method, or similar techniques. The adaptation may for example be similar to a standard gradient decent step in DNN training, where backpropagation is used to calculate the partial deviates.

The pre-trained artificial neural network, respectively the adapted artificial neural network obtained from the pre-trained artificial neural network may for example be any computing framework for machine learning algorithms to work together and process complex data inputs. For example, the pre-trained artificial neural network, respectively the adapted artificial neural network may be a deep neural network (DNN).

The embodiments disclose a process which creates an improved image from a distorted or low resolution original image. The mapping between the two is derived by adaptation of a pre-trained Deep Neural Network using data from the specific instance of the imager and the application, together with high-quality reference data that is supplied during a limited time period, called adaption process. As a result, a very high quality of the output image can be achieved, higher than with standard methods.

The method may comprise using the adapted artificial neural network to create an improved image from a degraded image by mapping the degraded image to the improved image. In the case that a pre-trained artificial neural network is trained using degraded data together with higher-quality reference data to obtain an adapted artificial neural network, the quality of the improved images is enhanced over upscaling with upscaling technology known from the prior art.

The lower quality (e.g. degraded) data is for example obtained under conditions related to the intended usage of the adapted artificial neural network. Intended usage may for example refer to the particular application in which the adapted artificial neural network is finally used for image enhancement. If the artificial neural network is trained based on degraded training data that is obtained under conditions from the specific instance of an imager and the application, other than a pre-trained static network, the artificial neural network according to the embodiments is not generic and static. The intended usage may also be referred to as “operational” usage.

The training may take into account any special characteristics (particular application) of the camera, lens, sensor, and/or compression scheme that is used during intended usage of the adapted artificial neural network.

If the adaptation takes into account, for example, any special property of the very camera, lens, or compression scheme that is being used in this particular application, as opposed to offline factory DNN training which is done using a generic training set, the artificial neural network can learn the specific image mapping necessary in the particular application (intended usage of the adapted neural network).

Other than a pre-trained static network, the adapted network according to the embodiments is not generic and static. Its properties do not only depend on the type of data that is captured in a static training image database, but it also takes into account the specific properties of the specific sensor at hand and in particular the specific type of input images that need improvement. Therefore, the quality of the improved images may be enhanced over upscaling with upscaling technology known from the prior art.

The lower-quality (degraded) data may for example take into account the specific type of degraded data that need improvement in the particular application. For example, if the adaptation is done using actual data from the particular application, for example liver data, the mapping does not need to learn how to map, say, images of a low resolution grassy meadow or images of the brain to high resolution images of the same, but can fully focus on liver cells. This also leads to higher quality images.

The degraded training data may be degraded data that relates to the high-quality reference data.

For example, the lower-quality data may result from the high-quality reference data by transmitting the high-quality reference data over a data link that does not support the full bandwidth necessary for transmitting the high-quality reference data

Alternatively, or in addition, the lower-quality data may result from the high-quality reference data by data compression. For example, compression might introduce artifacts that are highly undesirable in this problem setting and that should be mitigated by image enhancement. In the case of, for example, an operating room, where there is a higher-quality original signal but there are bandwidth limitations, it is possible to use the original signal supplied by a camera (e.g. of an endoscope) as higher-quality reference data. In other cases, a higher-quality camera can be temporarily used to generate the reference data, and after adaptation, it is no longer needed and can be used elsewhere.

The higher-quality reference data may for example be reference data that is generated on-the-fly during the adaption process using the hardware and the image content of the particular application. For the higher-quality reference, several methods can be employed.

For example, the higher-quality reference data is obtained with a higher-quality reference camera that is used along with degraded data that is captured side by side with a lower-quality camera.

According to some embodiments, the adaptation process happens during intended usage of the artificial neural network.

The adaption process may for example be performed during a limited time period at the beginning of intended usage of the neural network.

The method may further comprise pre-training an artificial neural network with generic training data to obtain the pre-trained artificial neural network. The pre-trained artificial neural network may for example depend on the type of data that is captured in a static training image database.

The degraded data may for example comprise a distorted or low resolution image. For example, the degraded data may be video data that comprises a sequence of video images (frames).

According to an embodiment, the adaptation process is done as a calibration step when devices are manufactured.

Adapting the pre-trained artificial neural network comprises updating the weights of the pre-trained artificial neural network using gradient descent and/or error backpropagation. The partial derivative of each of this pixel error signals with respect to each of the parameters of the Deep Neural Network is computed and, after one or several such images have been collected, the weights are updated by the accumulated partial derivatives multiplied by a small constant (the learning rate). This is the adaptation step, which is very similar to a standard backpropagation step in DNN training.

The degraded training data may for example comprise degraded images and the higher-quality reference data comprises higher-quality target images.

Adapting the pre-trained artificial neural network may comprise mapping a degraded image to an improved image (I1).

Still further, adapting the pre-trained artificial neural network may comprise aligning the improved image to a respective higher-quality target image.

Still further, adapting the pre-trained artificial neural network may comprise generating a difference image based on the improved image and the respective higher-quality target image.

The embodiments further disclose a method comprising: obtaining high quality reference data; obtaining lower quality data; and adapting a pre-trained artificial neural network using the higher-quality reference data together with the lower quality data to obtain an adapted artificial neural network.

The embodiments also disclose an electronic device comprising circuitry configured to create an improved image from a degraded image by mapping the degraded image to the improved image with an adapted artificial neural network, wherein the adapted artificial neural network is obtained by training a pre-trained artificial neural network using degraded data together with higher-quality reference data.

The circuitry may be configured to perform all or some of the processes described above and in the following details description of embodiments.

Circuitry may include a processor, a memory (RAM, ROM or the like), a storage, input means (mouse, keyboard, camera, etc.), output means (display (e.g. liquid crystal, (organic) light emitting diode, etc.), loudspeakers, etc., a (wireless) interface, etc., as it is generally known for electronic devices (computers, smartphones, etc.). Moreover, it may include sensors for sensing still image or video image data (image sensor, camera sensor, video sensor, etc.), for sensing a fingerprint, for sensing environmental parameters (e.g. radar, humidity, light, temperature), etc. In particular, the circuitry may comprise a DNN unit that may for example be a neural network on one or more GPUs or any other hardware specialized for the purpose of implementing an artificial neural network. Still alternatively, the circuitry may be configured to implement an artificial neural network by means of software. The circuitry may also be configured to run training algorithms such a stochastic gradient descent on the artificial neural network to adapt the neural network.

The embodiments also disclose a computer-implemented method comprising training a pre-trained artificial neural network using degraded data together with higher-quality reference data to obtain an adapted artificial neural network.

The embodiments also disclose a machine readable storage medium comprising instructions which when executed on a processor cause the processor to perform training a pre-trained artificial neural network using degraded data together with higher-quality reference data to obtain an adapted artificial neural network.

Embodiments are now described by reference to the drawings.

One example of the application of the disclosure of this application is an operating room in a hospital, in which video data needs to be transmitted from various image-capturing devices (endoscopes, high quality cameras, CT, pre-captured NMR etc) to multiple displays. Some or all of the data links might not support the full bandwidth of video data, and compression needs to be applied. Decompression might introduce artifacts that are highly undesirable in this problem setting. The inventive method provides a way how the quality of the displayed images and videos can be improved.

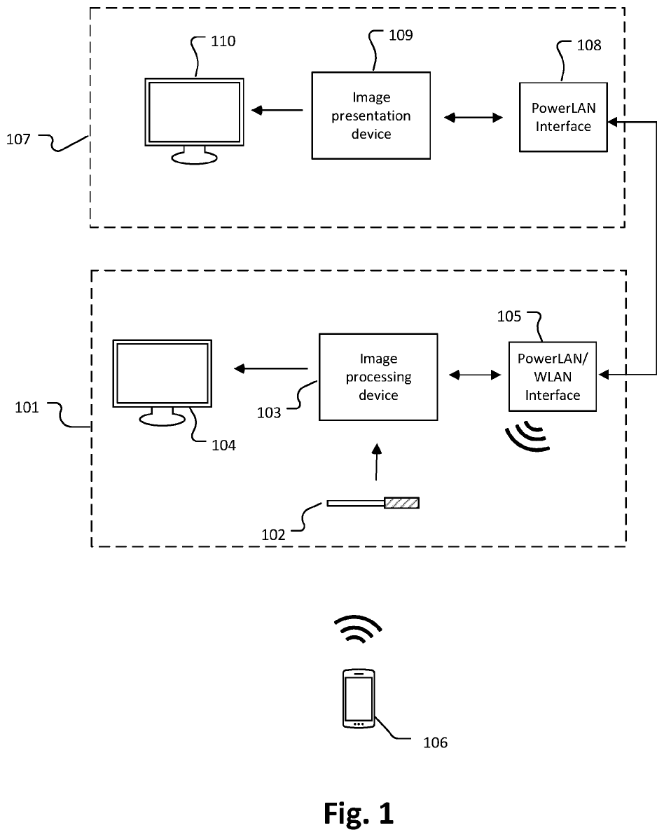

FIG. 1 describes an operating room where high quality video data is taken by an endoscope and is degraded by sending it through a bandwidth restricted PowerLAN connection to an operation surveillance room. The operating room 101 and the operation surveillance room 107 are communicationally connected via PowerLAN. To this end, a PowerLAN/WLAN interface 105 is provided in the operating room 101 and a PowerLAN interface 108 is provided in the operation surveillance room 107. In the operating room 101 an endoscope 102 is used to perform a medical procedure on a patient and capture video data with high quality. The high quality video data is sent from the endoscope 102 to an image processing device 103. The image processing device 103 displays the video data in its original quality on a display screen 104 so that a surgeon may control the endoscope 102 based on the feedback provided by display screen 104. Furthermore, the image processing device 103 sends the video data via the PowerLAN/WLAN interface 105 using PowerLAN transmission to the PowerLAN interface 108 in the operating surveillance room 107. The image presentation device 109 receives the video data submitted from the image processing device 103 via the PowerLAN interface 108. The bandwidth of the PowerLAN connection is strongly dependent on environmental influences such as interference factors from other devices or services using the same power lines. Video compression algorithms typically dynamically adapt to the current bandwidth conditions. Accordingly, the original video data of high quality may be received at the image presentation device 109 as video data of lower quality. The image presentation device 109 displays the lower quality video data on the screen 110. In the operation surveillance room 107, medical staff can observe the progress of the medical procedure conducted in operating room 101 and possibly other medical procedures conducted throughout the hospital for surveillance and/or training purposes. Furthermore, the image processing device 103 sends the original video data via the PowerLAN/WLAN interface 105 using WLAN transmission to a smartphone 106 which is for example worn by a surgeon who is not present in the operating room 101 but who has interests in following the progress of the medical procedure. Due to transmission errors through the WLAN transmission, for example due to bandwidth restrictions, the original high quality video data is received at the smartphone 106 as video data of lower quality.

In the embodiments described here in more detail, a PowerLAN connection is used as an example for a data connection which provides low quality data transmission. The embodiments are, however, not restricted to this type of data connection. The same principle applies to other low quality transmission channels, e.g. bandwidth limited connections such as Bluetooth or low bandwidth Ethernet.

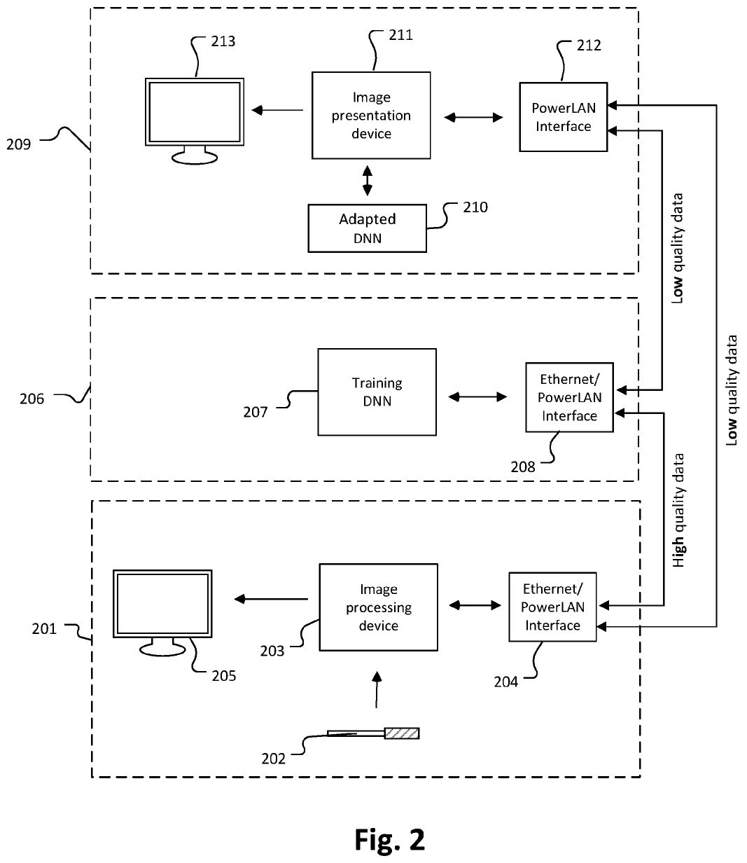

FIG. 2 describes an adaptation step of a pre-trained DNN that receives high quality video data and the corresponding degraded video data, where the DNN computations takes place in server. In the operating room 201 an endoscope 202 is used to perform a medical procedure on a patient and capture video data with high quality. The high quality video data is sent from the endoscope 202 to an image processing device 203. The image processing device 203 displays the video data in its original quality on a display screen 205 so that a surgeon may control the endoscope 202 based on the feedback provided by display screen 205. Furthermore, the image processing device 203 sends the high quality video data via an Ethernet/PowerLAN interface 204 using Ethernet transmission to an Ethernet interface 208 in the server room 206. A training deep neural network (Training DNN) receives the high quality video data submitted from the image processing device 203 via the Ethernet/PowerLAN interface 208. The training DNN learns to improve video data specific to this operational room setting and uses gradient descent and backpropagation algorithm to train its weights. Furthermore, the image processing device 203 sends the video data via the Ethernet/PowerLAN interface 204 using PowerLAN transmission to the PowerLAN interface 212 in the operating surveillance room 209. The image presentation device 211 receives the video data via the PowerLAN interface 212. Due to interference factors from other devices or services using the same power lines and/or bandwidth restrictions the original video data of high quality may be received at the image presentation device 211 in the operation surveillance room 209 as video data of lower quality. Using an adapted deep neural network (adapted DNN) 210 the image presentation device 211 is able to improve the received low quality video data and display improved video data at a screen 213. The adapted DNN receives regular updates from the training DNN and is therefore perfectly suited to improve low quality images, specialized on the errors and distortions specific to this exact setting.

The adapted pre-trained DNN (adapted DNN 210 in FIG. 2) does image improvement (e.g. upscaling) by using on-the-fly generated reference data using exactly the local hardware (camera, or other capturing device, here endoscope 202) and the local image content (say images of a liver in the case of endoscopic surgery of the liver). This additionally captured data is captured twice, once in degenerated quality (as obtained by image presentation device 211 via PowerLAN interface 212 in FIG. 2), and once in the desired (high) quality (as obtained by image processing device 203 from endoscope 202 in operation room 201).

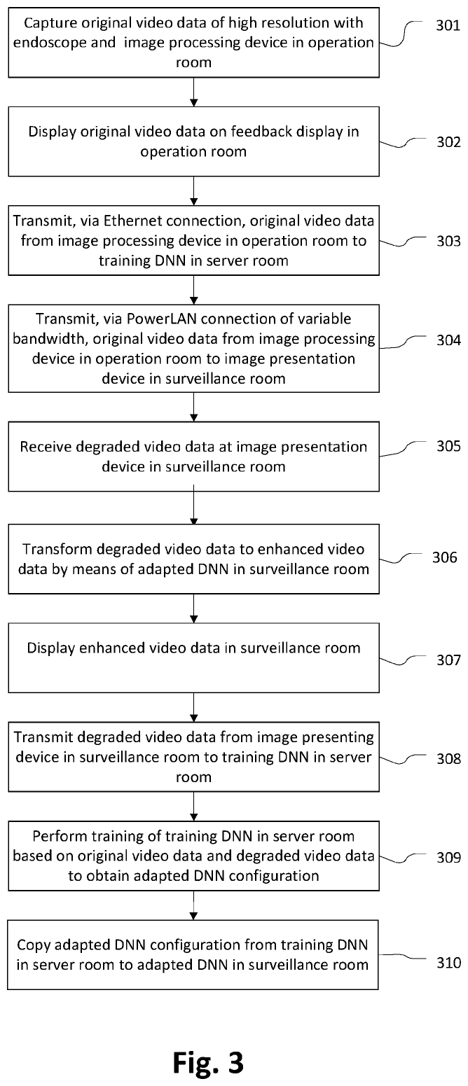

FIG. 3 shows a flowchart that describes the process of adaptation of a pre-trained DNN as shown in FIG. 2. At 301, the original video data of high resolution is captured with the endo scope 202 and transmitted to the image processing device 203 in the operation room 201. At 302, the original video data is displayed on feedback display 205 in the operating room 201. At 303, the original video data from image processing device 203 is transmitted, via Ethernet connection, to the training deep neural network (DNN) 207 in server room 206. At 304, the original video data from image processing device 203 in operation room 201 is transmitted, via a PowerLAN connection of variable bandwidth to the image presentation device 211 in surveillance room 209. At 305, the degraded video data is received at the image presentation device 211 in surveillance room 209. At 306, the degraded video data is transformed to an enhanced video data by means of the adapted adapted DNN 210 in surveillance room 209. At 307, the enhanced video data is displayed at the in display 213 in the surveillance room 209. At 308, the degraded video data is transmitted from the image presenting device 211 in surveillance room 209 to training DNN 207 in server room 206. At 309, the training of training DNN 207 is performed in server room based on the original video data and degraded video data to obtain an adapted DNN configuration. At 310, the adapted DNN configuration is copied from the training DNN 207 in server room 206 to adapted DNN 210 in surveillance room 209.

In the embodiment above the DNN is described by two distinguished functional units, i.e. the training DNN and the adapted DNN. Note, that nevertheless both distinguished functional units may be realized as one hardware component or as software component implemented on one electronic device.

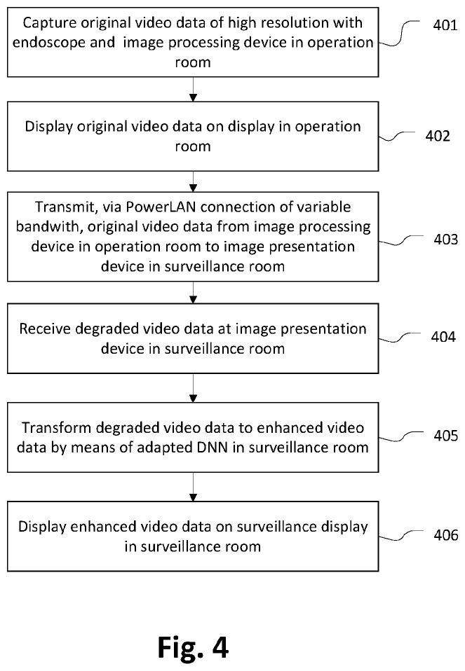

FIG. 4 shows a flowchart that describes the operation of an adapted DNN after adaptation step shown in FIG. 2 and FIG. 3 has taken place. At 401, the original video data is captured in high resolution with the endoscope 202 and send to the image processing device 203 in the operation room 201. At 402, the original video data is displayed at the display 205 in the operation room 201. At 403, the original video data from image processing device 203 in the operation room 201 is transmitted, via PowerLAN connection of variable bandwidth, to the image presentation device 211 in the operation surveillance room 209. At 404, the image presentation device 211 in the operation surveillance room 209 receives the degraded video data. At 405, the degraded video data is transformed to an enhanced video data by means of the adapted DNN 210 in the surveillance room 209. At 406, the enhanced video data is displayed at the display 213 in the surveillance room 209.

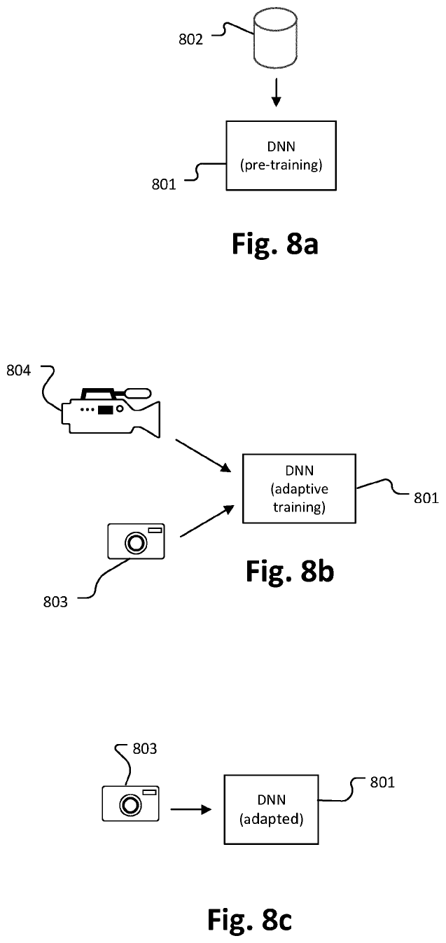

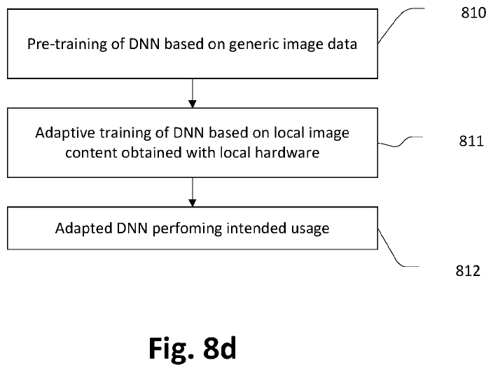

The actual adaptation stage which is performed in the embodiment of FIGS. 2 to 4 on a computer in the server room of the hospital is computationally intensive. To mitigate the computational efforts at local site, for the actual adaptation, it is also possible to upload the data into the cloud and perform the adaptation there. This has the further advantage that the original generic training database that has been used during initial parameter estimation of the Deep Neural Network (pre-training stage in step 801 of FIG. 8) can be used for adaptation (in addition to the adaptation data), by a supporting entity (e.g. a manufacturer or vendor) of the image improvement system. Generally, the availability of the original database leads to improved robustness of the adaptation result and is therefore advantageous.

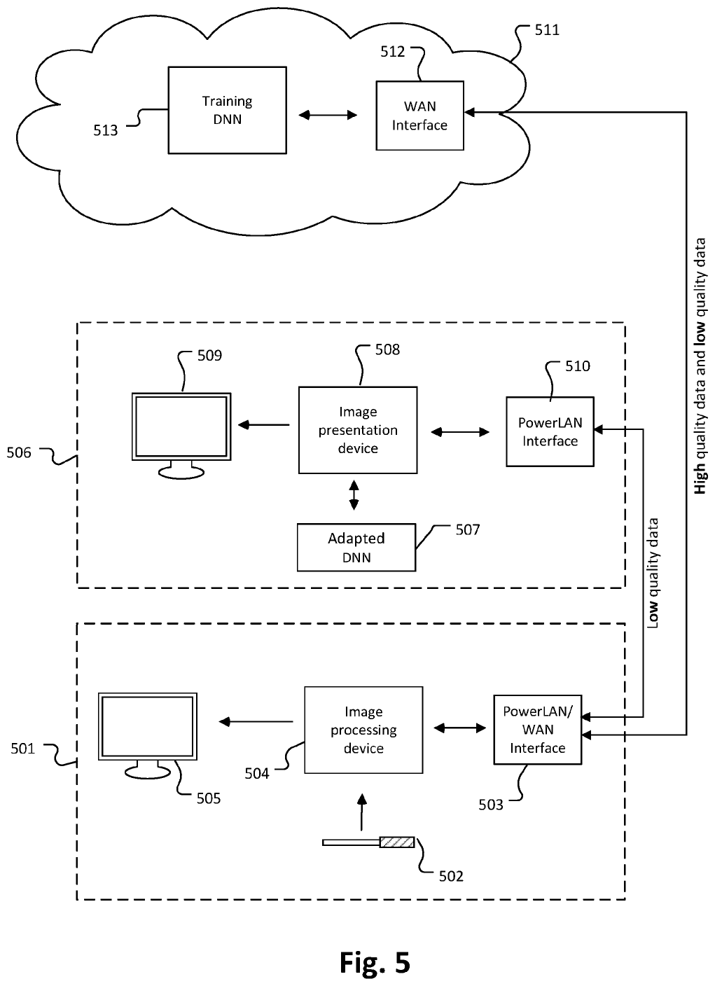

FIG. 5 describes an adaptation step of a pre-trained DNN that receives high quality video data and the corresponding degraded video data, where the DNN computations takes place in a cloud computing system.

In the operating room 501 an endoscope 502 is used to perform a medical procedure on a patient and capture video data with high quality. The high quality video data is sent from the endoscope 502 to an image processing device 504. The image processing device 504 displays the video data in its original quality on a display screen 505 so that a surgeon may control the endoscope 502 based on the feedback provided by display screen 505. Furthermore, the image processing device 504 sends the high quality video data via a PowerLAN/WAN interface 503 using PowerLAN transmission to a PowerLAN interface 510 in the operation surveillance room 506. The image presentation device 508 receives the video data submitted from the image processing device 504 via the PowerLAN interface 510.

Due to interference factors from other devices or services using the same power lines and/or bandwidth restrictions the original video data of high quality may be received at the image presentation device 508 in the operation surveillance room 506 as video data of lower quality. Using an adapted DNN 507 the image presentation device 508 is able to improve the received low quality video data and display an improved video data at a screen 509. The adapted DNN receives regular updates from a training DNN and is therefore perfectly suited to improve low quality video data specialized on the errors and distortions specific to this exact setting. Furthermore, the image processing device 504 sends the high quality video data via WAN (for example DSL or Ethernet) using the PowerLAN/WAN interface 503 to the cloud computing systems WAN Interface 512. The high quality video data is used in the cloud computing system 511 to train the training DNN 513.

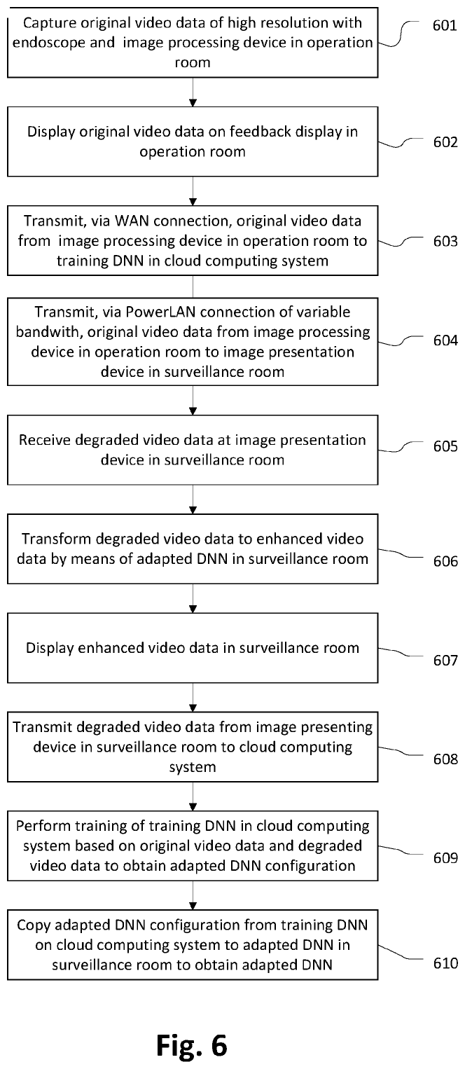

FIG. 6 shows a flowchart that describes the process of adaptation of a pre-trained DNN as shown in FIG. 5. At 501, the original video data of high resolution is captured with the endoscope 502 and transmitted to the image processing device 504 in the operation room 501. At 602, the original video data is displayed on feedback display 505 in the operating room 501. At 603, the original video data from image processing device 504 is transmitted, via WAN connection, to the training deep neural network (DNN) 513 on the cloud computing system 511. At 604, the original video data from image processing device 504 in operation room 501 is transmitted, via a PowerLAN connection of variable bandwidth to the image presentation device 508 in surveillance room 506. At 605, the degraded video data is received at the image presentation device 508 in surveillance room 506. At 606, the degraded video data is transformed to an enhanced video data by means of the adapted DNN 507 in the surveillance room 506. At 607, the enhanced video data is displayed at the display 509 in the surveillance room 506. At 608, the degraded video data is transmitted from the image presenting device 508 in surveillance room 506 to training DNN 513 at the cloud computing system 511. At 609, the training of training DNN 513 is performed on the cloud computing system based on the original video data and degraded video data to obtain an adapted DNN configuration. At 610, the adapted DNN configuration is copied from the training DNN 513 on the cloud computing system 511 to adapted DNN 507 in surveillance room 506.

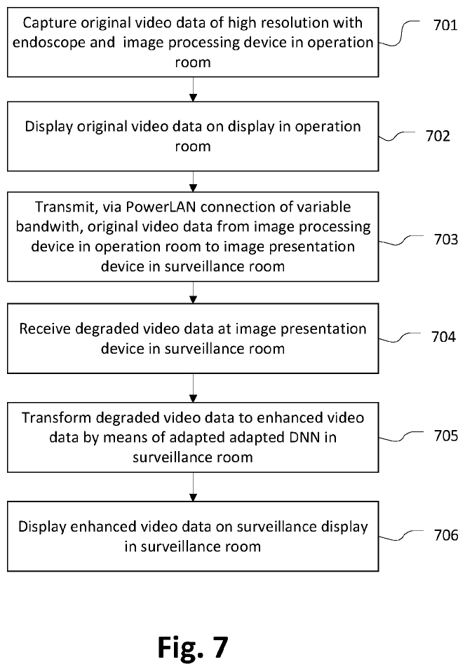

FIG. 7 shows a flowchart that describes the operation of an adapted DNN after an adaptation step shown in FIG. 5 and FIG. 6 has taken place. Irrespective if the adaptation of the training DNN was done on a local server or on a cloud computing system this will be the same. Therefore, FIGS. 4 and 7 are equal. 701, the original video data is captured in high resolution with the endoscope 502 and send to the image processing device 504 in the operation room 501. At 702, the original video data is displayed at the display 505 in the operation room 501. At 703, the original video data from image processing device 504 in the operation room 501 is transmitted, via PowerLAN connection of variable bandwidth, to the image presentation device 508 in the operation surveillance room 506. At 704, the image presentation device 508 in the operation surveillance room 506 receives the degraded video data. At 705, the degraded video data is transformed to an enhanced video data by means of the adapted DNN 507 in the surveillance room 506. At 706, the enhanced video data is displayed at the display 509 in the surveillance room 506.

FIG. 8a-FIG. 8c schematically show an embodiment of pre-training, adapting and operating a DNN. In FIG. 8a a DNN 801 is pre-trained with generic data 802. In FIG. 8b an adaptation step (training phase) is performed on the DNN 801. In this embodiment this is done through temporarily using a high quality image capturing device 804. Therefore, the low quality image captured by a low quality image capturing device 803 is aligned to a high quality target image captured by the high quality image capturing device 804. In FIG. 8c the adapted DNN 801 is used, after the training phase has finished, to improve the low quality images captured by the low quality image capturing device 803.

FIG. 8d shows a flowchart of the steps shown in FIG. 8a-FIG. 8c. At 810, Pre-training of DNN is performed based on generic image data. At 811, adaptive training of DNN is performed based on local image content obtained with local hardware. At 812, adapted DNN is operated according to the specific use case (intended usage) foreseen for the DNN.

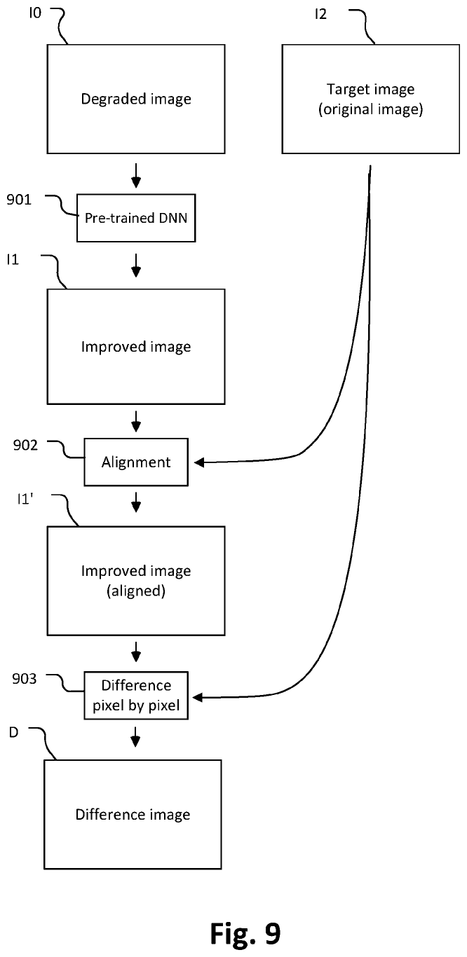

FIG. 9 schematically shows the process of a DNN performing an adaptation step by aligning an improved image to a target image. An input degraded image I0 is taken and is fed, at 901 to the pre-trained network to generate an improved image I1. The improved image I1 is then aligned, at 902, to the target image I2, which is the target (original high quality) image for this particular image enhancement, and after aligning, at 903, the difference D of the properly aligned image I1 to the image I2 is computed pixel by pixel. For the generation of the high quality reference images 12, several methods can be employed. In the case of the adaption process taking place during factory calibration of individual devices before shipping them (at the manufacturer), a high quality reference camera can be used along with test images which are captured side by side, to generate the adaptation data. In the case of the operating room, where there is a high quality original signal (e.g. the images provided by endoscope 202 of FIG. 2 available in image processing device 203) but there are bandwidth limitations (PowerLAN connection to surveillance room 209 in FIG. 2), the original signal can be obtained as high quality reference as described with regard to FIGS. 2 to 4 above. In other cases, a high quality camera can be temporarily used to generate the reference data, and after adaptation, it is no longer needed and can be used elsewhere.

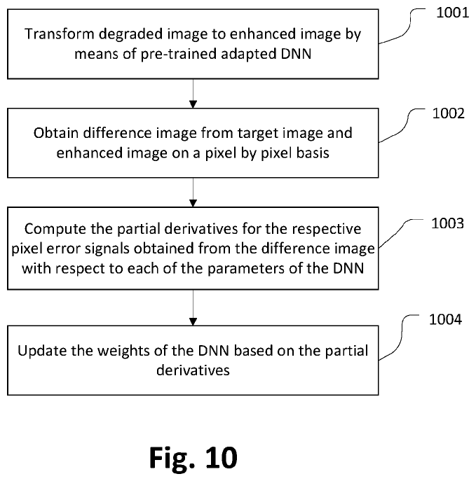

FIG. 10 shows a flowchart that describes the adaptation steps of the DNN by performing a gradient descent step. At 1001, the degraded image is transformed to an enhanced image by means of the pre-trained adapted DNN. At 1002, the difference image is obtained from the target (original) image and the enhanced image on a pixel by pixel basis. At 1003, the partial derivatives for the respective pixel error signals are obtained from the difference image with respect to each of the parameters of the DNN (the weights). Then, at 1004, the parameters of the DNN are updated based on the partial derivatives. That is, the parameters of the DNN are adapted such that the mapping from the original to the desired image is improved. This step can be achieved using a step of error backpropagation between the desired and the currently available improved image (using the pre-trained network), very similar to the initial training of the Deep Neural Network. The weights may for example be updated using a stochastic gradient descent method after one difference image has been collected, by multiplying the partial derivatives by a small constant (the learning rate). Or the weights may be updated using a batch gradient descent method after several such difference images have been collected, by multiplying the accumulated partial derivatives by a small constant (the learning rate). This adaptation step, is similar to a standard gradient decent step in DNN training, where backpropagation is used to calculate the partial deviates.

An advantage of the adaptation as described above lies in the specificity as opposed to the offline factory DNN training (see pre-training 801 in FIG. 8) which is done using a generic training set, the adaptation stage takes into account any special characteristics of the environment in which the DNN is operated, e.g. the particularities of the camera and lens, the compression scheme that is being used in this particular case. Therefore, the DNN can learn the specific mapping from degraded images to enhanced images better that a DNN that is trained solely based on a generic training set. Additionally, if the adaptation is done using actual data from the application (like the liver data in the example above), the mapping does not need to learn how to map, say, images of a low resolution grassy meadow or images of the brain to high resolution images of the same, but can fully focus on liver cells. This also leads to higher quality images.

Implementation

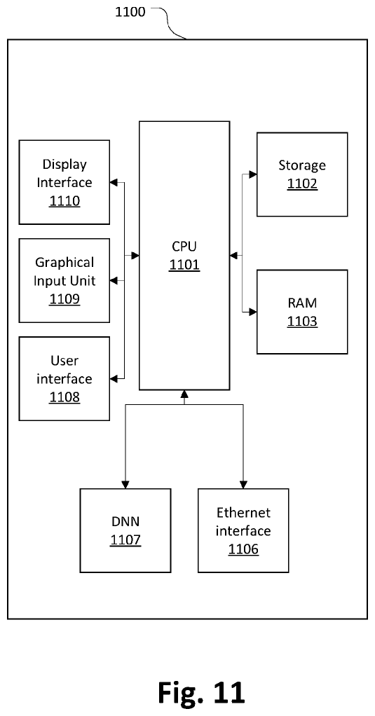

FIG. 11 schematically describes an embodiment of an electronic device which may implement the functionality of an artificial neural network. The electronic device may further implement a process of training a DNN and image improvement using a DNN as described in the embodiments above, a process of image presentation, or a combination of respective functional aspects. The electronic device 1100 comprises a CPU 1101 as processor. The electronic device 1100 further comprises a graphical input unit 1109 and deep neural network unit 1107 that are connected to the processor 1101. The graphical input unit 1109 may for example be connected to the endoscope 201. The electronic device 1100 further comprises a DNN unit 1107 that may for example be a neural network on GPUs or any other hardware specialized for the purpose of implementing an artificial neural network. Processor 1101 may for example implement the processing of the video data obtained via Ethernet interface 1105 (e.g. video data captured by the endoscope 202 in FIG. 2), pre-training of the DNN 1107 (see 810 in FIG. 8), adaptive training of the DNN 1107 (see 811 in FIG. 8) or the operation of the trained DNN (see 812 in FIG. 8). The electronic device 1100 further comprises a display interface 1110. This display interface 1110 is connected for example to an external screen (201 or 213 in the operation room or operation surveillance room, respectively). The electronic system 1100 further comprises an Ethernet interface 1105 which acts as interface for data communication with external devices. For example, via this Ethernet interface 1105 the electronic device can be connected to a PowerLAN interface and/or a WLAN interface (see e.g. 204, 208, 212 in FIG. 2).

The electronic device 1100 further comprises a data storage 1102 and a data memory 1103 (here a RAM). The data memory 1103 is arranged to temporarily store or cache data or computer instructions for processing by the processor 1101. The data storage 1102 is arranged as a long term storage, e.g., for recording video data obtained from the graphical input unit 1109. The data storage 1102 may also store data obtained from the DNN 1107.

It should be noted that the description above is only an example configuration. Alternative configurations may be implemented with additional or other sensors, storage devices, interfaces, or the like.

In the embodiments of FIG. 3 and FIG. 5, the DNN 210 and the image presentation device are displayed as separate functional units. It should however be noted that these functional units can be implemented in separate electronic devices which are, e.g. connected via a data communication interface such as Ethernet, or they could be implemented in the same electronic device in which case they constitute software running on the same hardware architecture.

It should be recognized that the embodiments describe methods with an exemplary ordering of method steps. The specific ordering of method steps is, however, given for illustrative purposes only and should not be construed as binding. For example steps 402 and 403 in FIG. 4, and/or steps 602, 603 and 604 in FIG. 6 could be exchanged, or the position of step 607 in FIG. 6 can be changed.

It should also be noted that the division of the electronic device of FIG. 11 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below:

(1) A method comprising adapting a pre-trained artificial neural network (207; 513) using higher-quality reference data together with lower quality data to obtain an adapted artificial neural network (210; 507).

(2) The method of (1) further comprising using the adapted artificial neural network (210; 507) to create an improved image (I1) from a degraded image (I0) by mapping the degraded image (I0) to the improved image (I1).

(3) The method of (1) or (2), wherein the degraded data is obtained under conditions related to the intended usage of the adapted artificial neural network (210; 507).

(4) The method of anyone of (1) to (3), wherein the training takes into account any characteristics of the camera (202; 502; 803), lens, sensor, and/or compression scheme that is used during intended usage of the adapted artificial neural network (210; 507).

(5) The method anyone of (1) to (4), wherein the degraded data takes into account the specific type of degraded data that need improvement in the particular application.

(6) The method anyone of (1) to (5), wherein the degraded data results from the high-quality reference data by transmitting the high-quality reference data over a data link (204, 212; 510, 503) that does not support the full bandwidth necessary for transmitting the high-quality reference data.

(7) The method of anyone of (1) to (6), wherein the degraded training data results from the high-quality reference data by data compression.

(8) The method of anyone of (1) to (7), wherein the higher-quality reference data is reference data that is generated on-the-fly using the hardware and the image content of a particular application.

(9) The method of anyone of (1) to (8), wherein the higher-quality reference data is obtained with a higher-quality reference camera (804) that is used along with degraded data that is captured side by side with a lower-quality camera (803).

(10) The method of anyone of (1) to (9), wherein the adaptation process happens during intended usage of the artificial neural network (210; 507).

(11) The method of anyone of (1) to (10), wherein the adaption process is performed during a limited time period at the beginning of intended usage of the adapted neural network.

(12) The method of anyone of (1) to (11), further comprising pre-training an artificial neural network with generic training data (802) to obtain the pre-trained artificial neural network.

(13) The method of anyone of (1) to (12), wherein the degraded data comprises a distorted or low resolution image (I0).

(14) The method of anyone of (1) to (13), wherein the adaptation process is done as a calibration step when devices are manufactured.

(15) The method of anyone of (1) to (14), wherein adapting the pre-trained artificial neural network (210; 507) comprises updating the weights of the pre-trained artificial neural network using gradient descent and/or error backpropagation.

(16) The method of anyone of (1) to (15), wherein the degraded training data comprises degraded images (I0) and the higher-quality reference data comprises higher-quality target images (I2).

(17) The method of anyone of (1) to (16), wherein adapting the pre-trained artificial neural network comprises mapping a degraded image (I0) to an improved image (I1).

(18) The method of anyone of (1) to (17), wherein adapting the pre-trained artificial neural network comprises aligning the improved image (I1) to a respective higher-quality target image (I2).

(19) The method of anyone of (1) to (18), wherein adapting the pre-trained artificial neural network comprises generating a difference image (D) based on the improved image (I1) and the respective higher-quality target image (I2).

(20) An electronic device (210; 1100) comprising circuitry configured to create an improved image from a degraded image by mapping the degraded image to the improved image with an adapted artificial neural network, wherein the adapted artificial neural network is obtained by training a pre-trained artificial neural network using degraded data together with higher-quality reference data.

(21) A method comprising:
obtaining high quality reference data;
obtaining lower quality data; and
adapting a pre-trained artificial neural network (207; 513) using the higher-quality reference data together with the lower quality data to obtain an adapted artificial neural network (210; 507).

1. A method comprising adapting a pre-trained artificial neural network using higher-quality reference data together with lower quality data to obtain an adapted artificial neural network.

2. The method of claim 1 further comprising using the adapted artificial neural network to create an improved image from a degraded image by mapping the degraded image to the improved image.

3. The method of claim 1, wherein the degraded data is obtained under conditions related to the intended usage of the adapted artificial neural network.

4. The method of claim 3, wherein the training takes into account any characteristics of the camera, lens, sensor, and/or compression scheme that is used during intended usage of the adapted artificial neural network.

5. The method of claim 1, wherein the degraded data takes into account the specific type of degraded data that need improvement in the particular application.

6. The method of claim 1, wherein the degraded data results from the high-quality reference data by transmitting the high-quality reference data over a data link that does not support the full bandwidth necessary for transmitting the high-quality reference data.

7. The method of claim 1, wherein the degraded training data results from the high-quality reference data by data compression.

8. The method of claim 1, wherein the higher-quality reference data is reference data that is generated on-the-fly using the hardware and the image content of a particular application.

9. The method of claim 1, wherein the higher-quality reference data is obtained with a higher-quality reference camera that is used along with degraded data that is captured side by side with a lower-quality camera.

10. The method of claim 1, wherein the adaptation process happens during intended usage of the artificial neural network

11. The method of claim 1, wherein the adaption process is performed during a limited time period at the beginning of intended usage of the adapted neural network.

12. The method of claim 1, further comprising pre-training an artificial neural network with generic training data to obtain the pre-trained artificial neural network.

13. The method of claim 1, wherein the degraded data comprises a distorted or low resolution image.

14. The method of claim 1, wherein the adaptation process is done as a calibration step when devices are manufactured.

15. The method of claim 1, wherein adapting the pre-trained artificial neural network comprises updating the weights of the pre-trained artificial neural network using gradient descent and/or error backpropagation.

16. The method of claim 1, wherein the degraded training data comprises degraded images and the higher-quality reference data comprises higher-quality target images.

17. The method of claim 1, wherein adapting the pre-trained artificial neural network comprises mapping a degraded image to an improved image.

18. The method of claim 17, wherein adapting the pre-trained artificial neural network comprises aligning the improved image to a respective higher-quality target image.

19. The method of claim 17, wherein adapting the pre-trained artificial neural network comprises generating a difference image based on the improved image and the respective higher-quality target image.

20. An electronic device comprising circuitry configured to create an improved image from a degraded image by mapping the degraded image to the improved image with an adapted artificial neural network, wherein the adapted artificial neural network is obtained by training a pre-trained artificial neural network using degraded data together with higher-quality reference data.
